(19) United States
(12) Patent Application Publication
(10) Pub. No.: US 2026/0028199 A1
(43) Pub. Date: Jan. 29, 2026

(54) SHEET CONVEYANCE APPARATUS AND IMAGE FORMING APPARATUS

(71) Applicant: CANON KABUSHIKI KAISHA, Tokyo (JP)

(72) Inventor: KENTA MIYAMOTO, Fukui (JP)

(21) Appl. No.: 19/277,858

(22) Filed: Jul. 23, 2025

(30) Foreign Application Priority Data
Jul. 29, 2024 (JP) 2024-122481

(51) Int. Cl. B65H 9/00; G03G 15/00

(52) U.S. Cl. CPC B65H 9/002; B65H 9/006; G03G 15/6567; B65H 2301/3613; B65H 2801/06; G03G 2215/00565

(57) ABSTRACT

A sheet conveyance apparatus includes a first roller pair, a second roller pair, a third roller pair, and a control unit configured to execute a first mode in which skew correction of the sheet is performed by abutting a leading edge of the sheet against the second roller pair in a stopped state, and then the sheet is passed through the third roller pair without abutting the leading edge of the sheet against the third roller pair in a stopped state, and a second mode in which the leading edge of the sheet is passed through the second roller pair without abutting against the second roller pair in the stopped state, and then skew correction of the sheet is performed by abutting the leading edge of the sheet against the third roller pair in the stopped state.

### BACKGROUND

### Field of the Technology

This disclosure relates to a sheet conveyance apparatus that conveys a sheet, and an image forming apparatus that includes the sheet conveyance apparatus.

### Description of the Related Art

Japanese Patent Laid-Open No. 2019-189367 describes an image forming apparatus that performs skew correction by abutting a leading edge of a sheet against a nip portion of a registration roller pair. In this image forming apparatus, a conveyance path is curved on an upstream side of the registration roller pair, and the sheet warps toward an outer side of a curve of the conveyance path during the skew correction.

### SUMMARY

This disclosure provides a sheet conveyance apparatus and an image forming apparatus that can realize enhanced accuracy in skew correction for a variety of sheets.

An aspect of the disclosure provides a sheet conveyance apparatus including a first roller pair configured to convey a sheet, a second roller pair arranged downstream of the first roller pair in a conveyance path of the sheet and configured to convey the sheet, a third roller pair arranged downstream of the second roller pair in the conveyance path and configured to convey the sheet, and a control unit, wherein, in a case where a movement direction of the sheet at a nip portion of the first roller pair is referred to as a first direction, a movement direction of the sheet at a nip portion of the second roller pair is referred to as a second direction, and a movement direction of the sheet at a nip portion of the third roller pair is referred to as a third direction, an angle between the first direction and the second direction is larger than an angle between the second direction and the third direction, wherein the control unit is configured to execute a first mode in a case of conveying the sheet having a first grammage and to execute a second mode in a case of conveying the sheet having a second grammage that is less than the first grammage, wherein the first mode is a mode in which skew correction of the sheet is performed by abutting a leading edge of the sheet against the second roller pair in a stopped state, and then the sheet is passed through the third roller pair without abutting the leading edge of the sheet against the third roller pair in a stopped state, and wherein the second mode is a mode in which the leading edge of the sheet is passed through the second roller pair without abutting against the second roller pair in the stopped state, and then skew correction of the sheet is performed by abutting the leading edge of the sheet against the third roller pair in the stopped state.

Another aspect of the disclosure provides a sheet conveyance apparatus including a first roller pair configured to convey a sheet, a second roller pair arranged downstream of the first roller pair in a conveyance path of the sheet and configured to convey the sheet, a third roller pair arranged downstream of the second roller pair in the conveyance path and configured to convey the sheet, and a control unit, wherein, in a case where a movement direction of the sheet at a nip portion of the first roller pair is referred to as a first direction, a movement direction of the sheet at a nip portion of the second roller pair is referred to as a second direction, and a movement direction of the sheet at a nip portion of the third roller pair is referred to as a third direction, an angle between the first direction and the second direction is smaller than an angle between the second direction and the third direction, wherein the control unit is configured to execute a first mode in a case of conveying the sheet having a first grammage, and is configured to execute a second mode in a case of conveying the sheet having a second grammage that is less than the first grammage, wherein the first mode is a mode in which a leading edge of the sheet is passed through the second roller pair without abutting against the second roller pair in a stopped state, and then skew correction of the sheet is performed by abutting the leading edge of the sheet against the third roller pair in a stopped state, and wherein the second mode is a mode in which skew correction of the sheet is performed by abutting the leading edge of the sheet against the second roller pair in the stopped state, and then the sheet is passed through the third roller pair without abutting the leading edge of the sheet against the third roller pair in the stopped state.

Another aspect of the disclosure provides a sheet conveyance apparatus including a first roller pair configured to convey a sheet, a second roller pair arranged downstream of the first roller pair in a conveyance path of the sheet and configured to convey the sheet, a third roller pair arranged downstream of the second roller pair in the conveyance path and configured to convey the sheet, and a control unit, wherein, in a case where a movement direction of the sheet at a nip portion of the first roller pair is referred to as a first direction, a movement direction of the sheet at a nip portion of the second roller pair is referred to as a second direction, and a movement direction of the sheet at a nip portion of the third roller pair is referred to as a third direction, an angle between the first direction and the second direction is larger than an angle between the second direction and the third direction, wherein the control unit is configured to execute a first mode in a case of conveying a first sheet, and is configured to execute a second mode in a case of conveying a second sheet having a lower stiffness than the first sheet, wherein the first mode is a mode in which skew correction of the sheet is performed by abutting a leading edge of the sheet against the second roller pair in a stopped state, and then the sheet is passed through the third roller pair without abutting the leading edge of the sheet against the third roller pair in a stopped state, and wherein the second mode is a mode in which the leading edge of the sheet is passed through the second roller pair without abutting against the second roller pair in the stopped state, and then skew correction of the sheet is performed by abutting the leading edge of the sheet against the third roller pair in the stopped state.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram illustrating an image forming apparatus according to an embodiment.

FIG. 2 is a schematic diagram illustrating a registration unit according to the embodiment.

FIG. 3 is a schematic diagram illustrating positional relationships among roller pairs according to the embodiment.

FIGS. 4A to 4E are explanatory diagrams of a thick paper mode according to the embodiment.

FIGS. 5A to 5E are explanatory diagrams of a thin paper mode according to the embodiment.

FIG. 6 is a flowchart illustrating a procedure for a print job according to the embodiment.

FIG. 7 is a block diagram illustrating a control configuration of the image forming apparatus according to the embodiment.

### DESCRIPTION OF THE EMBODIMENTS

Hereinafter, with reference to drawings, an embodiment according to this disclosure will be described.

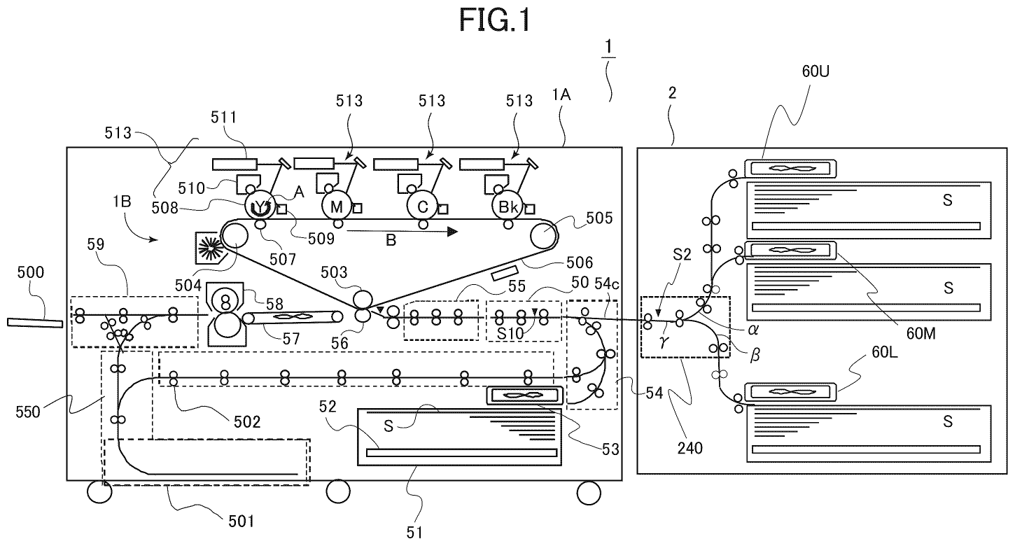

First, an overall configuration of an image forming apparatus 1 according to this embodiment will be described. FIG. 1 is a schematic diagram illustrating a cross-sectional configuration of the image forming apparatus 1. The image forming apparatus 1 includes an image forming apparatus body 1A and a sheet feeding apparatus 2 connected to the image forming apparatus body 1A.

The image forming apparatus 1 forms an image on a sheet S using an image forming unit 1B, while conveying the sheet S one sheet at a time. As the sheet S, serving as a recording material (recording medium), various types of sheet materials varying in sizes and materials, which include paper such as regular paper and thick paper, a surface treated sheet material such as coated paper, a specialty shaped sheet material such as an envelope and index paper, a plastic film, and cloth, can be used.

The image forming apparatus body 1A includes the image forming unit 1B employing a tandem-type intermediate transfer system, in which four process units 513 are arranged in a row along an intermediate transfer belt 506, serving as an intermediate transfer member. In a case of comparing with a direct transfer system, the intermediate transfer system offers an advantage of the easier accommodation of various types of the sheet S such as extra-thick paper and coated paper, since there is no need to hold the sheet S with transfer drums or a transfer belt. In addition, the tandem-type intermediate transfer system is well suited for achieving high productivity, owing to its features of parallel processing by the plurality of process units 513 and the collective transfer of a full color image formed by overlaying a plurality of toner images.

To be noted, the image forming unit 1B is an example of an image forming unit that forms the image on the sheet S, and it is acceptable to use an electrophotographic unit of the direct transfer system in which the toner images formed on photosensitive drums 508 are transferred onto the sheet S without using the intermediate transfer member. In addition, the image forming unit is not limited to the electrophotographic system, and, for example, may be a print unit of an inkjet process.

Each process unit 513 includes the photosensitive drum 508, a charge unit, an exposing unit 511, a developing unit 510, and a cleaning unit 509. The intermediate transfer belt 506 is stretched by a drive roller 504, a tension roller 505, and a secondary transfer inner roller 503, and is drivingly conveyed in an arrow B direction in FIG. 1. On an inner circumferential side of the intermediate transfer belt 506, primary transfer rollers 507 are arranged at positions corresponding to each photosensitive drum 508. In addition, on an outer circumferential side of the intermediate transfer belt 506, a secondary transfer roller 56 is arranged at a position opposing the secondary transfer inner roller 503 across the intermediate transfer belt 506.

In addition, the image forming apparatus body 1A includes an in-body feeding portion 51, an intermediate conveyance portion 54, a pre-registration conveyance portion 50, a skew feed correcting portion 55, a pre-fixing conveyance unit 57, a fixing unit 58, a branch conveyance portion 59, a reverse discharge portion 550, a duplex reversing portion 501, and a duplex conveyance portion 502.

A flow of an image forming operation will be described. Here, the sheet S is assumed to be fed from the in-body feeding portion 51.

The sheet S is stored in a storage compartment in a stacked state on a lift-up mechanism 52 provided in the in-body feeding portion 51. The sheet S is fed one sheet at a time by a sheet feeding unit 53 of the in-body feeding portion 51 in synchronization with the operation timing of the image forming unit 1B. The sheet feeding unit 53 employs either an air suction mechanism, in which the sheet S is attracted to a belt and conveyed by negative pressure generated by a fan, or a roller mechanism, in which friction from rollers rotating in contact with the sheet S is utilized. The sheet feeding unit 53 of FIG. 1 employs the air suction mechanism. The sheet S fed by the sheet feeding unit 53 passes through the intermediate conveyance portion 54 and the pre-registration conveyance portion 50, and is conveyed to the skew feed correcting portion 55.

A detection unit S10 that detects a leading edge of the sheet S is arranged in the pre-registration conveyance portion 50. Based on a detection result of the detection unit S10, the delay time of the sheet S with respect to the reference conveyance timing is measured, and, accordingly, a conveyance speed of the sheet S is controlled to offset the delay time. After skew correction has been performed in the skew feed correcting portion 55, the sheet S is sent to a secondary transfer portion. The secondary transfer portion is a nip portion formed between the secondary transfer roller 56 and the intermediate transfer belt 506.

In parallel with the conveyance operation of the sheet S to the secondary transfer portion described above, the toner image is formed in the image forming unit 1B. The photosensitive drum 508 and the intermediate transfer belt 506 are rotatably driven in predetermined directions A and B. In each process unit 513, a surface of the photosensitive drum 508 is charged by the charge unit. The exposing unit 511 performs the exposure of the photosensitive drum 508 based on image information, and writes an electrostatic latent image on the surface of the photosensitive drum 508. The developing unit 510 supplies toner, serving as developer, to the photosensitive drum 508, and develops the electrostatic latent image into a monochrome toner image of yellow, magenta, cyan, or black. These monochrome toner images are primarily transferred from the photosensitive drums 508 onto the intermediate transfer belt 506 by the primary transfer rollers 507. At this time, four monochrome toner images are superimposed on the intermediate transfer belt 506, and, thereby, the full color image is formed on the intermediate transfer belt 506. Transfer residual toner not transferred onto the intermediate transfer belt 506 but remained on the photosensitive drum 508 is collected by the cleaning unit 509.

By the rotation of the intermediate transfer belt 506, the full color image is conveyed to the secondary transfer portion. Then, in the secondary transfer portion, by applying voltage to the secondary transfer roller 56, the toner image is transferred from the intermediate transfer belt 506 onto the sheet S.

The sheet S which has passed through the secondary transfer portion is conveyed to the fixing unit 58 by the pre-fixing conveyance unit 57. The fixing unit 58 nips and conveys the sheet S by, for example, a roller pair, and fixes the image on the sheet S by heating the image on the sheet S using heat generated from a heat source such as a halogen lamp. By the branch conveyance portion 59, the sheet S which has passed through the fixing unit 58 is either directly discharged toward a sheet discharge tray 500 or guided to the reverse discharge portion 550. The image forming apparatus 1 can discharge the sheet S to the sheet discharge tray 500 in a state in which the sheet S is inverted by the reverse discharge portion 550 such that a surface onto which the image was transferred in the secondary transfer portion faces downward (face-down).

To be noted, in a case of duplex printing to form the image on both sides of the sheet S, the sheet S on whose first surface the image has been formed passes from the branch conveyance portion 59 to the reverse discharge portion 550, and is sent to the duplex reversing portion 501. Then, the sheet S which has been switchbacked in the duplex reversing portion 501 is sent to the intermediate conveyance portion 54 again via the duplex conveyance portion 502. Thereafter, after the image has been formed on a second surface in the same manner as on the first surface, the sheet S is discharged to the sheet discharge tray 500.

To be noted, the sheet S fed from the sheet feeding apparatus 2, described below, is conveyed to the pre-registration conveyance portion 50 via a conveyance path 54c of the intermediate conveyance portion 54. Operations subsequent to the pre-registration conveyance portion 50 are the same as those performed in a case where the sheet S is fed from the in-body feeding portion 51.

### Sheet Feeding Apparatus

The sheet feeding apparatus 2 according to this embodiment will be described. In this embodiment, the sheet feeding apparatus 2 feeds the sheet S toward the image forming apparatus body 1A. As illustrated in FIG. 1, the sheet feeding apparatus 2 of this embodiment includes vertically aligned three-tiered sheet feeding units 60U, 60M, and 60L, and a registration unit 240 which performs the skew correction of the sheet S. The registration unit 240 is an example of a sheet conveyance apparatus.

The sheet feeding units 60U, 60M, and 60L are provided with the same configuration as the in-body feeding portion 51. That is, each sheet feeding unit 60U, 60M, and 60L includes a storage compartment incorporating a lift-up mechanism and a feeding unit that feeds the sheet S one sheet at a time from the storage compartment.

The sheet S fed from the sheet feeding units 60U and 60M on upper and middle tiers is conveyed through an upper conveyance path α. The sheet S fed from the sheet feeding units 60L on a lower tier is conveyed through a lower conveyance path β. The upper and lower conveyance paths α and β merge at the registration unit 240, and become a horizontal path γ. The horizontal path γ extends in a substantially horizontal direction, and communicates with the conveyance path 54c of the image forming apparatus body 1A. Therefore, the sheet S fed from each sheet feeding unit 60U, 60M, and 60L is conveyed to the image forming apparatus body 1A via the registration unit 240.

As with the in-body feeding portion 51 of the image forming apparatus body 1A, in the image forming operation, the sheet S is fed from any of the sheet feeding unit 60U, 60M, or 60L in synchronization with the operation timing of the image forming unit 1B. A second conveyance sensor S2 for detecting the leading edge of the sheet S is arranged in the horizontal path γ. A control unit of the image forming apparatus 1 pauses the conveyance of the sheet S based on the detection of the leading edge of the sheet S by the second conveyance sensor S2, and resumes the conveyance of the sheet S in synchronization with the operation timing of the image forming unit 1B. Thereby, the sheet S can be fed to the image forming apparatus body 1A with the conveyance timing fluctuations that occurred inside the sheet feeding apparatus 2 corrected.

### Registration Unit

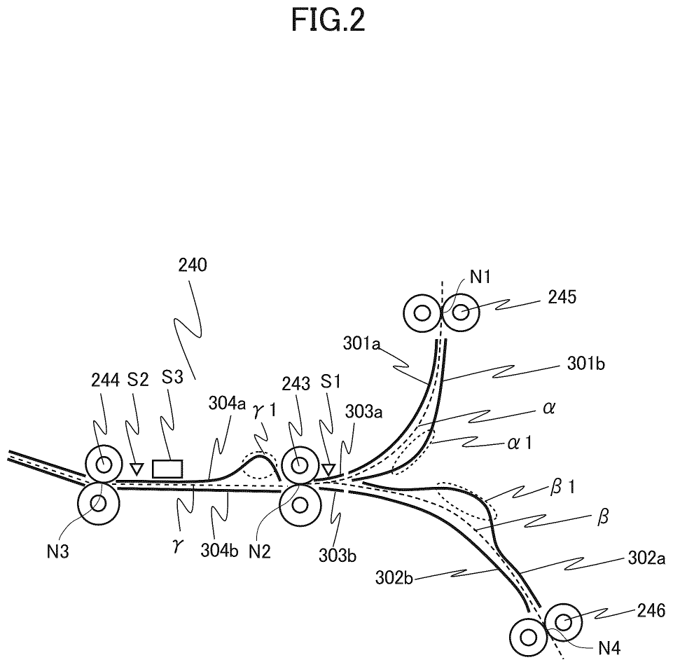

Next, the registration unit 240 according to this embodiment will be described. FIG. 2 is a cross-sectional view illustrating the registration unit 240. As illustrated in FIG. 2, the registration unit 240 includes a first registration roller pair 243 and a second registration roller pair 244. In addition, the registration unit 240 includes an upper conveyance roller pair 245 and a lower conveyance roller pair 246.

The upper conveyance roller pair 245 is an example of a first roller pair that conveys the sheet S. The first registration roller pair 243 is an example of a second roller pair that is arranged downstream of the first roller pair in a conveyance path of the sheet S and conveys the sheet S. The second registration roller pair 244 is an example of a third roller pair that is arranged downstream of the second roller pair in the conveyance path of the sheet S and conveys the sheet S.

The lower conveyance roller pair 246 is an example of a fourth roller pair that, in a case where the upper conveyance path α and the horizontal path γ are referred to as a first conveyance path, is arranged in a second conveyance path (lower conveyance path β) which merges with the first conveyance path. To be noted, in a case where the sheet feeding apparatus 2 does not include the upper conveyance path α, the lower conveyance roller pair 246 can be referred to as the first roller pair.

The first and second registration roller pairs 243 and 244 are arranged in the horizontal path γ. The second registration roller pair 244 is positioned downstream of the first registration roller pair 243 in a sheet conveyance direction in the horizontal path γ.

The upper conveyance roller pair 245 is arranged in the upper conveyance path α, and is positioned upstream of the first registration roller pair 243 in a sheet conveyance direction in the upper conveyance path α. The lower conveyance roller pair 246 is arranged in the lower conveyance path β, and is positioned upstream of the first registration roller pair 243 in a sheet conveyance direction in the lower conveyance path β.

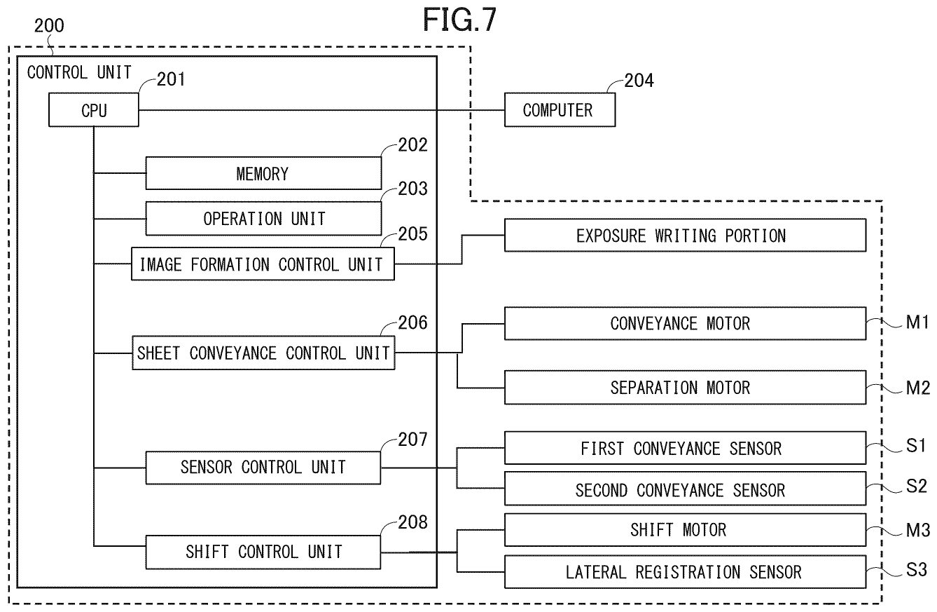

Each roller pair (243, 244, 245, 246) includes a drive roller, which is rotatably driven by a driving force of a conveyance motor M1 (FIG. 7), and a driven roller, which forms a nip portion N1, N2, N3, or N4 with the drive roller and rotates following the drive roller. In this embodiment, to enable the independent control of the rotational drive of each roller pair (243, 244, 245, 246), a dedicated conveyance motor M1 is provided for each roller pair. In addition, each roller pair (243, 244, 245, 246) is configured such that the drive roller and the driven roller are capable of engaging and disengaging with each other (nip portion can be opened and closed) by a driving force of a separation motor M2 (FIG. 7). In this embodiment, to enable the independent control of the opening and closing of each roller pair (243, 244, 245, 246), a dedicated separation motor M2 is provided for each roller pair. Further, the second registration roller pair 244 is configured to perform a shift movement in a sheet width direction by a driving force of a shift motor M3 (FIG. 7). The sheet width direction is a direction parallel to rotational axes of the second registration roller pair 244. The shift motor M3 serves as a moving unit for moving the second registration roller pair 244 (third roller pair) in the sheet width direction based on a detection result of a lateral registration sensor S3.

Between the upper conveyance roller pair 245 and the first registration roller pair 243, the upper conveyance path α is formed by an upper guide 301a (first guide) and a lower guide 301b (second guide). Between the upper conveyance roller pair 245 and the first registration roller pair 243, the upper conveyance path α is curved such that the lower guide 301b is positioned on an outer side of a curve and the upper guide 301a is positioned on an inner side of the curve. A distance between the lower guide 301b (outer guide) and the upper guide 301a (inner guide) is expanded in an intermediate section between the upper conveyance roller pair 245 and the first registration roller pair 243, compared to portions adjacent to the upper conveyance roller pair 245 and the first registration roller pair 243. Therefore, in the intermediate section between the upper conveyance roller pair 245 and the first registration roller pair 243, a space al that allows the sheet S to warp (form a loop) outward with respect to the curve of the upper conveyance path α is formed.

Between the lower conveyance roller pair 246 and the first registration roller pair 243, the lower conveyance path β is formed by an upper guide 302a and a lower guide 302b. Between the lower conveyance roller pair 246 and the first registration roller pair 243, the lower conveyance path β is curved such that the lower guide 302b is positioned on an inner side of a curve and the upper guide 302a is positioned on an outer side of the curve. A distance between the lower guide 302b (inner guide) and the upper guide 302a (outer guide) is expanded in an intermediate section between the lower conveyance roller pair 246 and the first registration roller pair 243, compared to portions adjacent to the lower conveyance roller pair 246 and the first registration roller pair 243. Therefore, in the intermediate section between the lower conveyance roller pair 246 and the first registration roller pair 243, a space β1 that allows the sheet S to warp (form a loop) outward with respect to the curve of the lower conveyance path β is formed.

The upper and lower conveyance paths α and β converge at a position adjacent to an upstream side of the first registration roller pair 243. A conveyance path which is more downstream than a merging portion of the upper and lower conveyance paths α and β is formed by an upper guide 303a and a lower guide 303b.

Between the first and second registration roller pairs 243 and 244, the horizontal path γ is formed by an upper guide 304a (third guide) and a lower guide 304b (fourth guide). Part of the upper guide 304 is recessed upward. In other words, the upper guide 304a includes a concave portion (retraction portion) in which part of the upper guide 304a in the sheet conveyance direction is recessed to withdraw (retract) from the lower guide 304b. Thereby, between the first and second registration roller pairs 243 and 244, a space γ1 that allows the sheet S to warp (form a loop) upward is formed.

In addition, the registration unit 240 includes a first conveyance sensor S1, the second conveyance sensor S2, and the lateral registration sensor S3. The first conveyance sensor S1 is arranged at a position adjacent to the upstream side of the first registration roller pair 243. The second conveyance sensor S2 and the lateral registration sensor S3 are arranged at positions adjacent to an upstream side of the second registration roller pair 244.

The first and second conveyance sensors S1 and S2 are used to acquire passage timings of the leading and trailing edges of the sheet S so as to control a sheet conveyance operation. The first conveyance sensor S1 is used, for example, for conveyance control (loop amount control) when performing the skew correction by abutting the leading edge of the sheet S against the nip portion N2 of the first registration roller pair 243. The second conveyance sensor S2 is used, for example, for the conveyance control (loop amount control) when performing the skew correction by abutting the leading edge of the sheet S against the nip portion N3 of the second registration roller pair 244.

The lateral registration sensor S3 is, for example, a line sensor of a contact image sensor (CIS) method, including photodetectors arrayed in the sheet width direction. The lateral registration sensor S3 functions as a position detection unit capable of acquiring information on an edge position of the sheet S in the sheet width direction. The lateral registration sensor S3 is used for aligning a lateral position (lateral registration) of the image formed by the image forming unit 1B with respect to the sheet S in the sheet width direction (main scanning direction). In this embodiment, based on the detection result of the lateral registration sensor S3, the lateral registration is performed by conducting the shift movement of the second registration roller pair 244 in the sheet width direction with the sheet S nipped by the second registration roller pair 244. To be noted, the lateral registration method may also be a method in which an image formation position by the image forming unit 1B (for example, an initial latent image writing position during exposure) is adjusted in accordance with a position of the sheet S detected by the lateral registration sensor S3 or the like.

### Positional Relationships of Roller Pairs in Registration Unit

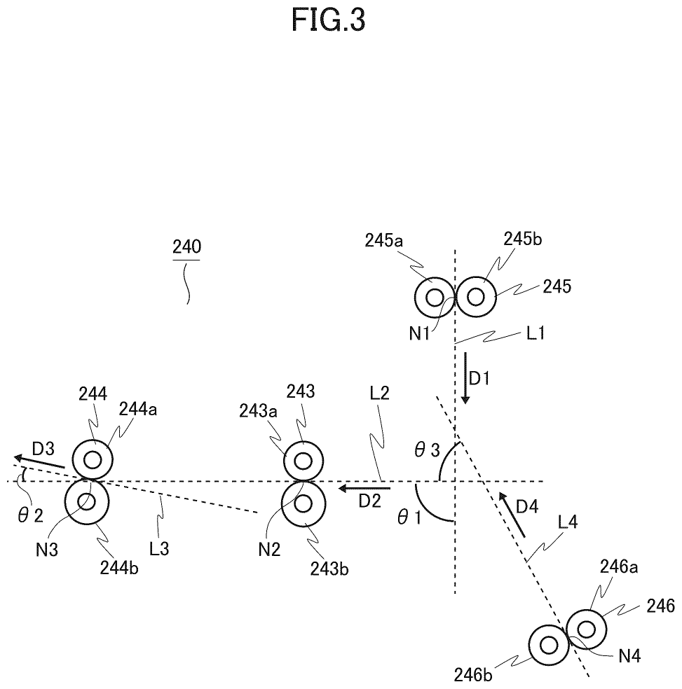

Using FIG. 3, positional relationships of the roller pairs in the registration unit 240 will be described. FIG. 3 is a schematic diagram illustrating the registration unit 240 when viewed in the sheet width direction.

In the following description, nip lines L1, L2, L3, and L4 are defined as follows. The nip line L1 of the upper conveyance roller pair 245 is a straight line that passes through the nip portion N1 of the upper conveyance roller pair 245 and perpendicularly intersects with a straight line connecting rotational axes of two rollers 245a and 245b included in the upper conveyance roller pair 245. The nip line L2 of the first registration roller pair 243 is a straight line that passes through the nip portion N2 of the first registration roller pair 243 and perpendicularly intersects with a straight line connecting rotational axes of two rollers 243a and 243b included in the first registration roller pair 243. The nip line L3 of the second registration roller pair 244 is a straight line that passes through the nip portion N3 of the second registration roller pair 244 and perpendicularly intersects with a straight line connecting rotational axes of two rollers 244a and 244b included in the second registration roller pair 244. The nip line L4 of the lower conveyance roller pair 246 is a straight line that passes through the nip portion N4 of the lower conveyance roller pair 246 and perpendicularly intersects with a straight line connecting rotational axes of two rollers 246a and 246b included in the lower conveyance roller pair 246. Each nip line L1 to L4 may also be referred to as a tangent to the roller pair (245, 243, 244, 246) at the nip portions N1 to N4.

A movement direction of the sheet S in the nip portion N1 of the upper conveyance roller pair 245 is referred to as a nip line direction D1 of the upper conveyance roller pair 245. A movement direction of the sheet S in the nip portion N2 of the first registration roller pair 243 is referred to as a nip line direction D2 of the first registration roller pair 243. A movement direction of the sheet S in the nip portion N3 of the second registration roller pair 244 is referred to as a nip line direction D3 of the second registration roller pair 244. A movement direction of the sheet S in the nip portion N4 of the lower conveyance roller pair 246 is referred to as a nip line direction D4 of the lower conveyance roller pair 246. The nip line directions D1, D2, D3, and D4 are directions respectively parallel to the nip lines L1, L2, L3, and L4.

An angle between the nip line direction D1 of the upper conveyance roller pair 245 and the nip line direction D2 of the first registration roller pair 243 is referred to as θ1. Similarly, an angle between the nip line direction D2 of the first registration roller pair 243 and the nip line direction D3 of the second registration roller pair 244 is referred to as θ2. An angle between the nip line direction D4 of the lower conveyance roller pair 246 and the nip line direction D2 of the first registration roller pair 243 is referred to as θ3. It is assumed that each angle θ1, θ2, and θ3 is equal to or more than 0 degrees and less than 360 degrees.

The angles θ1, θ2, and θ3 can be respectively referred to as angles formed between a direction vector of the nip line L1 and a direction vector of the nip line L2, between the direction vector of the nip line L2 and a direction vector of the nip line L3, and between a direction vector of the nip line L4 and the direction vector of the nip line L2. The angle θ1 is one of angles formed between the nip line L1 of the upper conveyance roller pair 245 and the nip line L2 of the first registration roller pair 243. The angle θ2 is one of angles formed between the nip line L2 of the first registration roller pair 243 and the nip line L3 of the second registration roller pair 244. The angle θ3 is one of angles formed between the nip line L4 of the lower conveyance roller pair 246 and the nip line L2 of the first registration roller pair 243.

In this embodiment, angular magnitudes among the angles θ1, θ2, and θ3 are such that θ1>θ2, and θ3>θ2. In addition, in this embodiment, specific values of the angles θ1, θ2, and θ3 are, for example, θ1=90 degrees, θ2=7 degrees, and θ3=78 degrees, but are not limited to these values.

That is, a shift amount (θ1) of the sheet S in the movement direction in a section from the upper conveyance roller pair 245 to the first registration roller pair 243 is greater than a shift amount (θ2) of the sheet S in the movement direction in a section from the first registration roller pair 243 to the second registration roller pair 244. In other words, a bending angle of the upper conveyance path α in the section from the upper conveyance roller pair 245 to the first registration roller pair 243 is larger than a bending angle of the horizontal path γ in the section from the first registration roller pair 243 to the second registration roller pair 244. In addition, a shift amount (θ3) of the sheet S in the movement direction in a section from the lower conveyance roller pair 246 to the first registration roller pair 243 is larger than the shift amount (θ2) of the sheet S in the movement direction in a section from the first registration roller pair 243 to the second registration roller pair 244. In other words, a bending angle of the lower conveyance path β in the section from the lower conveyance roller pair 246 to the first registration roller pair 243 is larger than the bending angle of the horizontal path γ in the section from the first registration roller pair 243 to the second registration roller pair 244.

In a configuration in which the skew correction is performed by warping the sheet in a conveyance path between a registration roller pair and an upstream conveyance roller pair regardless of the grammage or material of the sheet, sometimes, it is difficult to achieve sufficient accuracy in the skew correction for both high-stiffness sheets such as thick paper and low-stiffness sheets such as thin paper. In this embodiment, a configuration that can realize sufficient accuracy in the skew correction for both the high-stiffness sheets such as thick paper and the low-stiffness sheets such as thin paper is proposed.

### Correction Operation

A correction operation performed by the registration unit 240 in this embodiment will be described separately for a case where the sheet S is the high-stiffness sheets such as thick paper, and for a case where the sheet S is the low-stiffness sheets such as thin paper. Hereinafter, a mode (first mode) of the correction operation with respect to the sheet S whose stiffness is high is referred to as “thick paper mode”, and a mode (second mode) of the correction operation with respect to the sheet S whose stiffness is low is referred to as “thin paper mode”.

To be noted, as the correction operation, the registration unit 240 of this embodiment performs the skew correction of the sheet S and the correction of a sheet position in the sheet width direction (lateral registration). While, in the following, a case where the sheet S is conveyed via the upper conveyance path α will be described, by substituting “the upper conveyance roller pair 245” with “the lower conveyance roller pair 246”, the same description also applies to a case where the sheet S is conveyed via the lower conveyance path β.

### Thick Paper Mode

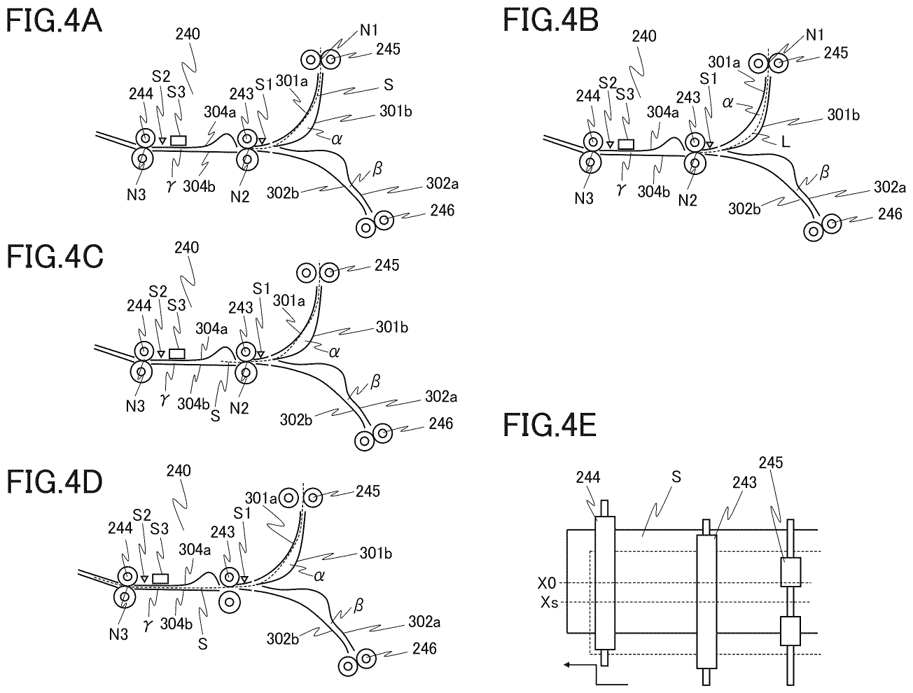

FIGS. 4A to 4E are diagrams illustrating the correction operation of the registration unit 240 in the thick paper mode. The sequence of FIGS. 4A to 4D corresponds to the chronological order of the correction operation. FIG. 4E is a schematic diagram illustrating the registration unit 240 at the same point in time as FIG. 4D as viewed from above.

As illustrated in FIG. 4A, the sheet S is conveyed from the upper conveyance roller pair 245 toward the first registration roller pair 243 via the upper conveyance path α. At this point in time, the first registration roller pair 243 is not being rotatably driven, and in a stopped state. Even after the leading edge of the sheet S is detected by the first conveyance sensor S1, the stopped state of the first registration roller pair 243 is maintained until a predetermined time has passed.

During a stoppage period of the first registration roller pair 243, the leading edge of the sheet S is abutted against the nip portion N2 of the first registration roller pair 243, and the upper conveyance roller pair 245 continues to convey the sheet S even after abutment. Thereby, as illustrated in FIG. 4B, the warp (loop L) of the sheet S is formed between the upper conveyance roller pair 245 and the first registration roller pair 243. At this time, the formation of the loop Lis allowed by the space al (FIG. 2) on a side of the lower guide 301b of the upper conveyance path α described above. To be noted, in the case of the sheet conveyance via the lower conveyance path β, the formation of the loop L is allowed by the space β1 (FIG. 2) on a side of the upper guide 302a.

When the loop L of the sheet S is formed, stress attempting to eliminate the loop Lis generated in the sheet S. Due to this stress, the leading edge of the sheet S rotates so as to align with the nip portion N2 of the first registration roller pair 243. That is, in a case where there is the skew of the sheet S (inclination of the leading edge of the sheet S with respect to the sheet width direction), one (advancing side) of two corners of the leading edge of the sheet S reaches the nip portion N2 earlier than the other (lagging side). Thereafter, in conjunction with the formation of the loop L, the leading edge of the sheet S rotates such that the lagging side corner portion moves downstream in the sheet conveyance direction using the advancing side corner portion as a fulcrum, and the skew of the sheet S is corrected.

When the predetermined time has passed after the leading edge of the sheet S was detected by the first conveyance sensor S1, as illustrated in FIG. 4C, the rotational drive of the first registration roller pair 243 is started, and the conveyance of the sheet S by the first registration roller pair 243 is started. In addition, after starting the drive of the first registration roller pair 243, the nip portion N1 of the upper conveyance roller pair 245 is opened. By opening the nip portion N1 of the upper conveyance roller pair 245, it is possible to prevent an increase in conveyance resistance caused by the loop L of the sheet S rubbing against the lower guide 301b.

After starting the conveyance of the sheet S by the first registration roller pair 243, the sheet edge position in the sheet width direction is detected by the lateral registration sensor S3 (FIG. 4D). Then, as illustrated in FIG. 4E, based on the detection result of the lateral registration sensor S3, during a period in which the second registration roller pair 244 nips and conveys the sheet S, the shift movement of the second registration roller pair 244 in the sheet width direction is performed. During the shift movement of the second registration roller pair 244, by opening the nip portions N2 and N1 of the first registration roller pair 243 and the upper conveyance roller pair 245, which are arranged more upstream than the second registration roller pair 244, the resistance of the sheet S against the movement in the sheet width direction is reduced.

As illustrated in FIG. 4E, in this embodiment, the shift movement of the second registration roller pair 244 is performed to align a center line Xs of the sheet S in the sheet width direction with a conveyance center line X0. The conveyance center line X0 serves as the reference for a sheet position in the sheet width direction. In addition, the image forming unit 1B forms the toner image by assuming that the center line Xs aligns with the conveyance center line X0.

In the thick paper mode (first mode) of this embodiment, the skew correction of the sheet S in the second registration roller pair 244 is not performed. That is, in the thick paper mode (first mode), the leading edge of the sheet S passes through the second registration roller pair 244 without being abutted against the second registration roller pair 244 (third roller pair) which is in the stopped state.

After the shift movement of the second registration roller pair 244, as described above, the sheet S is discharged from the sheet feeding apparatus 2 (FIG. 1), and the image is formed on the sheet S in the image forming apparatus body 1A.

Here, in the case of performing the skew correction of the sheet S whose stiffness is high, it is preferable to form the loop L in the section between the upper conveyance roller pair 245 and the first registration roller pair 243, in which the bending angle of the conveyance path is large. Thereby, it is possible to reduce the likelihood of skew correction failure due to leading edge penetration into the nip portion N2 of the first registration roller pair 243 and the slippage of the upper conveyance roller pair 245.

In particular, due to the warp of the sheet S along the conveyance path and the formation of the loop L during the skew correction, a force (bending stress) that attempts to extend the sheet S in a planar fashion is generated in the sheet S. This force acts on the leading edge of sheet S as a thrust force directed downstream in the sheet conveyance direction, and as a force directed toward the outer side of the curvature of the sheet S in a thickness direction of the sheet S. In addition, this force acts on the trailing edge of sheet S as a thrust force directed upstream in the sheet conveyance direction, and as a force directed toward the outer side of the curvature of the sheet S in the thickness direction of the sheet S.

The force that attempts to extend the sheet S in the planar fashion increases as the stiffness of the sheet S increases. Therefore, in the case of performing the skew correction of the sheet S whose stiffness is high, it is concerned that the skew correction failure may be caused by the penetration of advancing side corner portion of the leading edge of the sheet S through the nip portion N2 of the first registration roller pair 243 due to the force in the thrust direction. In addition, if the upper conveyance roller pair 245, which needs to press the sheet S toward the first registration roller pair 243 while forming the loop L, slips against the sheet S due to the force in the thrust direction, the loop L is not formed sufficiently. As a result, it is concerned that the skew correction failure may occur.

On the other hand, a relationship between a component of the force in the thrust direction and a component of the force in the thickness direction applied to the leading or trailing edge of the sheet S varies depending on the magnitude of the curvature of the sheet S. That is, in a state in which the sheet S is substantially curved, among forces acting on the leading and trailing edges of the sheet S due to the force attempting to extend the sheet S in the planar fashion, the component of the force in the thickness direction increases, while the component of the force in the thrust direction is relatively reduced.

In this embodiment, the sheet S whose stiffness is high undergoes the skew correction in a state of being substantially curved between the upper conveyance roller pair 245 and the first registration roller pair 243. Therefore, the force in the thrust direction applied to the leading edge of the sheet S during the skew correction is relatively reduced. As a result, it is possible to suppress the occurrence of the skew correction failure due to the advancing side corner portion of the sheet leading edge penetrating through the nip portion N2 of the first registration roller pair 243. In addition, the force in the thrust direction applied to the trailing edge of the sheet S during the skew correction is also comparatively reduced. As a result, it is possible to suppress the occurrence of the skew correction failure due to the upper conveyance roller pair 245 slipping against the sheet S.

### Thin Paper Mode

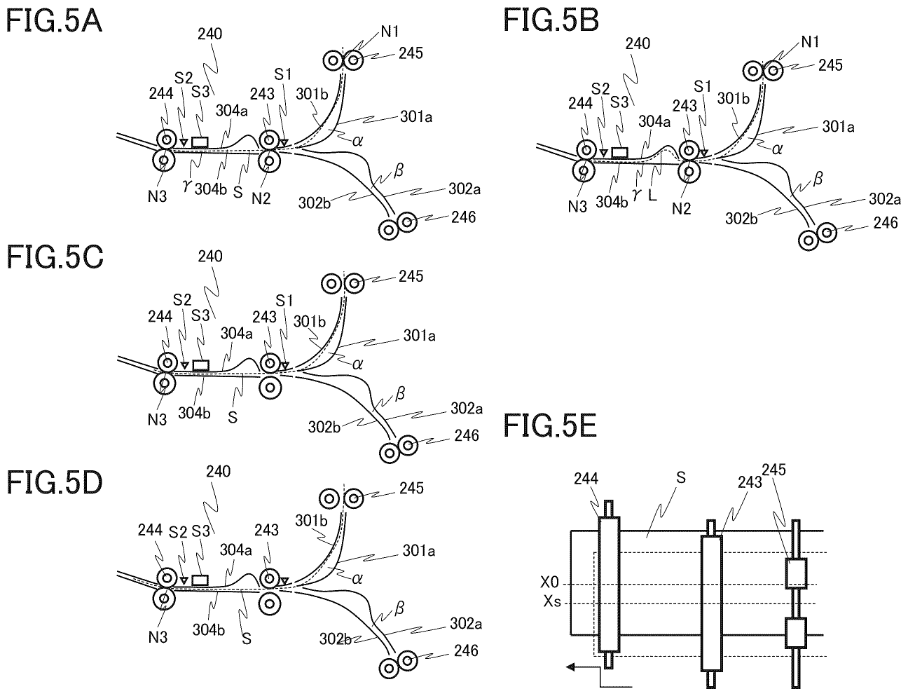

FIGS. 5A to 5E are diagrams illustrating the correction operation of the registration unit 240 in the thin paper mode. The sequence of FIGS. 5A to 5D corresponds to the chronological order of the correction operation. FIG. 5E is a schematic diagram illustrating the registration unit 240 at the same point in time as FIG. 5D as viewed from above.

As illustrated in FIG. 5A, in the thin paper mode (second mode) of this embodiment, the skew correction of the sheet S in the first registration roller pair 243 is not performed. That is, in the thin paper mode (second mode), the leading edge of the sheet S passes through the first registration roller pair 243 without being abutted against the first registration roller pair 243 (second roller pair) which is in the stopped state.

As illustrated in FIG. 5A, the sheet S is conveyed from the first registration roller pair 243 toward the second registration roller pair 244. At this point in time, the second registration roller pair 244 is not being rotatably driven, and in the stopped state. Even after the leading edge of the sheet S is detected by the second conveyance sensor S2, the second registration roller pair 244 is maintained in the stopped state until a predetermined time has passed.

During a stoppage period of the second registration roller pair 244, the leading edge of the sheet S is abutted against the nip portion N3 of the second registration roller pair 244, and the first registration roller pair 243 continues to convey the sheet S even after abutment. Thereby, as illustrated in FIG. 5B, the warp (loop L) of the sheet S is formed between the first and second registration roller pairs 243 and 244. At this time, the formation of the loop L is allowed by the space γ1 (FIG. 2) on a side of the upper guide 304a of the horizontal path γ described above.

When the loop L of the sheet S is formed, stress that attempts to eliminate the loop L is generated in the sheet S. Due to this stress, the leading edge of the sheet S rotates so as to align with the nip portion N3 of the second registration roller pair 244. That is, in a case where there is the skew of the sheet S, one (advancing side) of two corners of the leading edge of the sheet S reaches the nip portion N3 earlier than the other (lagging side). Thereafter, in conjunction with the formation of the loop L, the leading edge of the sheet S rotates such that the lagging side corner portion moves downstream in the sheet conveyance direction using the advancing side corner portion as a fulcrum, and the skew of the sheet S is corrected. That is, while, during the skew correction in the thick paper mode (FIG. 4B), the sheet S warps downward in a vertical direction, the sheet S warps upward in the vertical direction during the skew correction in the thin paper mode (FIG. 5B).

When the predetermined time has passed after the leading edge of the sheet S was detected by the second conveyance sensor S2, as illustrated in FIG. 5C, the rotational drive of the second registration roller pair 244 is started, and the conveyance of the sheet S by the second registration roller pair 244 is started. In addition, after starting the drive of the second registration roller pair 244, the nip portions N1 and N2 of the upper conveyance roller pair 245 and the first registration roller pair 243 are opened. By opening the nip portions N1 and N2, it is possible to prevent an increase in conveyance resistance caused by the loop L of the sheet S rubbing against the upper guide 304a.

In addition, after starting the conveyance of the sheet S by the second registration roller pair 244, the sheet edge position in the sheet width direction is detected by the lateral registration sensor S3 (FIG. 5D). Then, as illustrated in FIG. 5E, based on the detection result of the lateral registration sensor S3, during a period in which the second registration roller pair 244 nips and conveys the sheet S, the shift movement of the second registration roller pair 244 in the sheet width direction is performed. During the shift movement of the second registration roller pair 244, the nip portions N2 and N1 of the first registration roller pair 243 and the upper conveyance roller pair 245, which are arranged more upstream than the second registration roller pair 244, are maintained in an open state. Thereby, the resistance of the sheet S against the movement in the sheet width direction is reduced.

Here, in the case of performing the skew correction of the sheet S whose stiffness is low, it is preferable to form the loop L in a section between the first and second registration roller pairs 243 and 244, in which the bending angle of the conveyance path is small. Thereby, it is possible to reduce the likelihood of the skew correction failure due to insufficient rotation at the leading edge of the sheet S.

In particular, a force attempting to extend the sheet S in the planar fashion decreases as the stiffness of the sheet S decreases. Therefore, in a case of performing the skew correction of the sheet S whose stiffness is low, even in a state in which the loop Lis formed, the thrust force applied to leading edge of the sheet may be insufficient, and it is concerned that the skew correction failure may occur due to the lagging side corner portion being unable to catch up to the advancing side corner portion.

On the other hand, for the reasons described above, in a state in which the curvature of the sheet S is small, among the forces acting on the leading and trailing edges of the sheet S due to a force that attempts to extend the sheet S in the planar fashion, the component of the force in the thrust direction increases, and the component of the force in the thickness direction is relatively reduced.

In this embodiment, the sheet S whose stiffness is low undergoes the skew correction by forming the loop L in the substantially linear horizontal path γ between the first and second registration roller pairs 243 and 244. Therefore, the force in the thrust direction applied to the leading edge of the sheet S during the skew correction comparatively increases. As a result, it is possible to rotate the leading edge of the sheet S such that the corner portion of the leading edge of the sheet on the lagging side catches up to the corner portion on the advancing side, and is possible to suppress the occurrence of the skew correction failure.

### Control Configuration

FIG. 7 is a block diagram illustrating a control configuration of the image forming apparatus 1 in this embodiment. Each element in FIG. 7 except for a computer 204 may be mounted inside the image forming apparatus body 1A, or may be mounted within the sheet feeding apparatus 2.

The image forming apparatus 1 includes a control unit 200, serving as a controller or a control circuit to control an overall operation of the image forming apparatus 1, and various motors (M1 to M3) and various sensors (S1 to S3) connected to the control unit 200. The control unit 200 controls the operation of the registration unit 240.

The control unit 200 includes a central processing unit (CPU) 201, a memory 202, an operation unit 203, an image formation control unit 205, a sheet conveyance control unit 206, a sensor control unit 207, and a shift control unit 208. The image formation control unit 205, the sheet conveyance control unit 206, the sensor control unit 207, and the shift control unit 208 are function execution units provided in the control unit 200. These function execution units may be configured as dedicated processors (such as application-specific integrated circuits (ASICs)) independent from the control unit 200, or may be implemented in software as part of programs executed by the CPU 201.

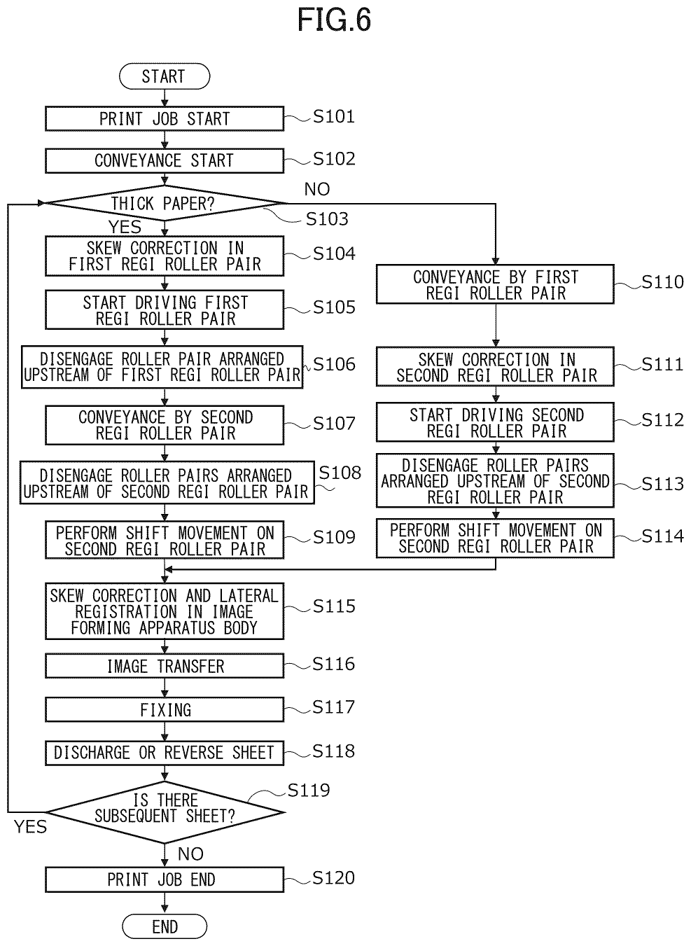

The CPU 201 reads and executes the programs stored in the memory 202, serving as a storage unit, and, by providing commands to each function execution unit, performs a print job in accordance with a flowchart (FIG. 6) described below. In addition, the CPU 201 is communicatively connected to the external computer 204 of the image forming apparatus 1 via an external interface and a network.

The operation unit 203 is a user interface of the image forming apparatus 1, and includes an input portion for receiving setting information and operation instructions with respect to the image forming apparatus 1 from a user, and a display portion for displaying information to the user. The image formation control unit 205 controls the operation of the image forming unit 1B. The image formation control unit 205, for example, controls an operation of an exposure writing portion that drives the exposing unit 511 based on the image information that the CPU 201 received from the computer 204. The sheet conveyance control unit 206 performs drive control of the conveyance motors M1 and the separation motors M2. To be noted, as described above, the registration unit 240 of this embodiment is driven by the plurality of conveyance motors M1 and the plurality of separation motors M2. The sensor control unit 207 receives a signal from various sensors, including the first and second conveyance sensors S1 and S2. The shift control unit 208 receives the detection result of the lateral registration sensor S3, and performs the drive control of the shift motor M3.

### Flow of Print Job

Next, with reference to FIG. 6, a procedure by which the control unit 200 of this embodiment executes the print job will be described, with special focus on the correction operation in the registration unit 240.

For example, in a case of receiving a print execution instruction from the user through the external computer 204, the control unit 200 starts the print job (STEP S101). The print job refers to a series of tasks that execute the image forming operation based on instructions received from the user. The print job includes user set parameters, such as the number of copies, number of pages, and attribute information for the sheet S used in printing. The attribute information for the sheet S includes information on the grammage and dimensions of the sheet S, and brand designation of the sheet S.

When the print job is started, the control unit 200 controls the sheet feeding apparatus 2 (or in-body feeding portion 51) to start feeding the sheet S (STEP S102). The control unit 200 analyses the attribute information for the sheet S obtained at the reception of the print job, and determines whether to apply the thick paper mode or the thin paper mode (STEP S103). As an example, in this embodiment, the grammage of the sheet S serves as a reference: in a case where the grammage is equal to or greater than 151 grams per square meter (g/m²), the thick paper mode is applied; in a case where the grammage is equal to or less than 150 g/m², the thin paper mode is applied. However, the threshold for the grammage can be modified, and, by taking into account the attribute information other than the grammage (for example, the existence and absence of surface treatment), whether to apply the thick paper mode or the thin paper mode may be determined.

In a case of the thick paper mode (STEP S103: YES), as described above, the control unit 200 abuts the leading edge of the sheet S against the first registration roller pair 243, which is in the stopped state, and forms the loop L (STEP S104). When a predetermined time T1 has passed after the detection of the leading edge by the first conveyance sensor S1, the control unit 200 starts the conveyance of the sheet S by the first registration roller pair 243 (STEP S105). When a predetermined waiting time has passed since the start of the conveyance by the first registration roller pair 243, the control unit 200 disengages the roller pair (245) arranged upstream of the first registration roller pair 243 (STEP S106). The roller pair disengaged at STEP S106 is again engaged prior to the arrival of the leading edge of a subsequent sheet.

Next, the control unit 200 passes the sheet S through the nip portion N3 of the second registration roller pair 244 without performing the skew correction again in the second registration roller pair 244, and controls the second registration roller to convey the sheet S (STEP S107). When a predetermined waiting time has passed since the arrival of the leading edge of the sheet S at the nip portion N3 of the second registration roller pair 244, the control unit 200 disengages the roller pairs (243) arranged upstream of the second registration roller pair 244 (STEP S108). The roller pairs disengaged at STEP S108 are again engaged prior to the arrival of the leading edge of the subsequent sheet.

After disengaging the upstream roller pairs at STEP S108, while continuing the conveyance of the sheet S by the second registration roller pair 244, the control unit 200 performs the shift drive of the second registration roller pair 244 based on the detection result of the lateral registration sensor S3 (STEP S109). Then, the control unit 200 discharges the sheet S from the sheet feeding apparatus 2 to the image forming apparatus body 1A.

Thereafter, after performing the final skew correction and lateral registration of the sheet S in the skew correction portion 55 (FIG. 1) of the image forming apparatus body 1A (STEP S115), the control unit 200 transfers the image onto the sheet S at the secondary transfer portion of the image forming unit 1B (STEP S116). Further, after fixing the image on the sheet S by the fixing unit 58 (STEP S118), the control unit 200 performs the reversal and discharge of the sheet S in accordance with whether or not settings for the duplex printing and face-down output are present (STEP S119). In a case where there is a subsequent sheet S necessitating the image formation (STEP S119: YES), the control unit 200 continues processing after returning to STEP S103. In a case where there is not the subsequent sheet S (STEP S119: NO), the control unit 200 ends the print job (STEP S120).

On the other hand, in a case of the thin paper mode, as described above, the control unit 200 passes the sheet S through the nip portion N2 of the first registration roller pair 243 without performing the skew correction in the first registration roller pair 243, which is in the stopped state, and conveys the sheet S using the first registration roller pair 243 (STEP S110). Thereafter, the control unit 200 abuts the leading edge of the sheet S against the second registration roller pair 244, which is in the stopped state (STEP S111).

When a predetermined time T2 has passed after the detection of the leading edge by the second conveyance sensor S2, the control unit 200 starts the conveyance of the sheet S by the second registration roller pair 244 (STEP S112). When a predetermined waiting time has passed since the start of the conveyance by the second registration roller pair 244, the control unit 200 disengages the roller pairs (245, 243) arranged upstream of the second registration roller pair 244 (STEP S113). The roller pairs disengaged at STEP S113 are engaged again prior to the arrival of the leading edge of the subsequent sheet.

After disengaging the upstream roller pairs at STEP S113, while continuing the conveyance of the sheet S by the second registration roller pair 244, the control unit 200 performs the shift drive of the second registration roller pair 244 based on the detection result of the lateral registration sensor S3 (STEP S114). Then, the control unit 200 discharges the sheet S from the sheet feeding apparatus 2 to the image forming apparatus body 1A. The subsequent processing (STEPS S115 to S120) of the print job is identical to that in the case of the thick paper mode, and the description will be omitted herein.

### Summary of this Embodiment

In this embodiment, the angle θ1 between the nip line direction D1 of the upper conveyance roller pair 245 and the nip line direction D2 of the first registration roller pair 243 is larger than the angle θ2 between the nip line direction D2 of the first registration roller pair 243 and the nip line direction D3 of the second registration roller pair 244. In other words, a movement direction of the sheet in the nip portion N1 of the upper conveyance roller pair 245 (first roller pair) is referred to as a first direction (D1). A movement direction of the sheet in the nip portion N2 of the first registration roller pair 243 (second roller pair) is referred to as a second direction (D2). A movement direction of the sheet in the nip portion N3 of the second registration roller pair 244 (third roller pair) is referred to as a third direction (D3). In this case, the angle θ1 between the first direction (D1) and the second direction (D2) is larger than the angle θ2 between the second and third directions (θ1>θ2).

The control unit 200 of this embodiment can execute the thick paper mode (first mode) and the thin paper mode (second mode) as operational modes of the registration unit 240. In the thick paper mode, after the skew correction of the sheet is performed by abutting the leading edge of the sheet against the first registration roller pair 243, which is in the stopped state, the sheet is passed through the second registration roller pair 244 (third roller pair) without abutting the leading edge of the sheet against the second registration roller pair 244, which is in the stopped state. In the thin paper mode, after passing through the first registration roller pair 243 without abutting the leading edge of the sheet against the first registration roller pair 243 (second roller pair), which is in the stopped state, the skew correction of the sheet is performed by abutting the leading edge of the sheet against the second registration roller pair 244 (third roller pair), which is in the stopped state.

Then, the control unit 200 of this embodiment executes the thick paper mode (first mode) in a case where the sheet has a first grammage, and executes the thin paper mode (second mode) in a case where the sheet has a second grammage, which is less than the first grammage. The first grammage is, for example, 190 g/m², which is equal to or larger than 151 g/m², and the second grammage is, for example, 60 g/m², which is equal to or less than 150 g/m². The first grammage may be an extra-thick paper with a grammage of equal to or larger than 500 g/m². The second grammage may be an extra-thin paper with a grammage of equal to or less than 52 g/m².

With the configuration described above, in the thick paper mode, the skew correction of the sheet is performed in the first registration roller pair 243 while forming the loop in the conveyance path in which the angle θ1 between the nip line directions D1 and D2 is large. Therefore, as described above, the likelihood of the skew correction failure caused by the leading edge penetration at the nip portion N2 of the first registration roller pair 243 and the slippage of the upper conveyance roller pair 245 can be reduced. In addition, in the thin paper mode, the skew correction of the sheet is performed in the second registration roller pair 244, while forming the loop in the conveyance path in which the angle θ2 between the nip line directions D2 and D3 is small. Therefore, as described above, the likelihood of the skew correction failure due to the insufficient force in the thrust direction for rotating the leading edge of the sheet S during the loop formation can be reduced.

That is, according to this embodiment, it is possible to provide the sheet conveyance apparatus and the image forming apparatus that can achieve enhanced accuracy in the skew correction for a variety of sheets, primarily with differing grammages.

In addition, in this embodiment, the upper conveyance path α (sheet conveyance path) formed by the upper guide 301a (first guide) and the lower guide 301b (second guide) is curved such that the lower guide 301b is positioned on the outer side of the curve. Further, the upper guide 301a (first guide) and the lower guide 301b (second guide) are configured to allow the sheet S to warp outward with respect to the curve of the upper conveyance path α when performing the skew correction of the sheet S in the thick paper mode (first mode).

Thereby, it is possible to perform the skew correction in the thick paper mode with the sheet S substantially curved along the curved upper conveyance path α. As a result, the likelihood of the skew correction failure caused by the leading edge penetration at the first registration roller pair 243 and the slippage of the upper conveyance roller pair 245 can be more reliably reduced.

In addition, in this embodiment, the nip portion N2 of the first registration roller pair 243 (second roller pair) is arranged below the nip portion N1 of the upper conveyance roller pair 245. The nip line direction D1 (first direction) of the upper conveyance roller pair 245 is directed downward in the vertical direction, and is closer to a vertical axis than to a horizontal axis. On the other hand, the nip line direction D2 (second direction) of the first registration roller pair 243 is closer to the horizontal axis than to the vertical axis.

With this configuration, in a case of attempting to perform the skew correction by abutting the sheet S, whose stiffness is low, against the first registration roller pair 243, there is a possibility that, even before the formation of the loop, part of the sheet S may warp downward due to gravity. In this case, there is a possibility that the skew correction failure may occur due to the insufficient loop amount after the abutment against the first registration roller pair 243. With the configuration of this embodiment, since the skew correction is not performed in the first registration roller pair 243 with respect to the sheet S, whose stiffness is low, such a problem can be avoided.

In addition, in this embodiment, the upper guide 304a (third guide) and the lower guide 304b (fourth guide) are configured to allow the sheet to warp upward when performing the skew correction of the sheet S in the thin paper mode (second mode). In other words, in the thin paper mode, the space γ1 (FIG. 2) for accommodating the loop L of the sheet S in the thin paper mode is disposed on an upper side of the horizontal path γ. Since the thin paper (especially, extra thin paper) has low stiffness, if the space γ1 for accommodating the loop Lis disposed on a lower side of the horizontal path γ, there is a possibility that the sheet S may warp toward the space γ1 even before the formation of the loop and may cause the skew correction failure. With the configuration of this embodiment, such a problem can be avoided.

In addition, in this embodiment, the angle θ3 between the nip line direction D4 of the lower conveyance roller pair 246 and the nip line direction D2 of the first registration roller pair 243 is larger than the angle θ2 between the nip line direction D2 of the first registration roller pair 243 and the nip line direction D3 of the second registration roller pair 244. In other words, a movement direction of the sheet at the nip portion N4 of the lower conveyance roller pair 246 (fourth roller pair) is referred to as a fourth direction (D4). In this case, the angle θ3 between the fourth direction (D4) and the second direction (D2) is larger than the angle θ2 between the second and third directions (θ3>θ2). Then, the control unit 200 executes the thick paper mode (first mode) in a case of conveying the sheet of a high grammage through lower conveyance path β (second conveyance path), and executes the thin paper mode (second mode) in a case of conveying the sheet of a low grammage through the lower conveyance path β (second conveyance path).

Thereby, by conveying the sheet through the plurality of conveyance paths, it becomes possible to accommodate a variety of sheets, and, at the same time, realize enhanced accuracy in the skew correction for the variety of sheets.

To be noted, the magnitude relationship between the angles θ1 and θ3 is θ1>θ3. That is, the bending angle of the upper conveyance path α between the upper conveyance roller pair 245 and the first registration roller pair 243 is larger than the bending angle of the lower conveyance path β between the lower conveyance roller pair 246 and the first registration roller pair 243. In this case, for example, a conveyance distance from the lower conveyance roller pair 246 to the first registration roller pair 243 may be set longer than a conveyance distance from the upper conveyance roller pair 245 to the first registration roller pair 243. Thereby, in the case of conveying the thick paper through the lower conveyance path β, it is possible to suppress the leading edge penetration at the first registration roller pair 243 and the slippage of the upper conveyance roller pair 245. However, the conveyance distance is defined as a distance measured along the conveyance path from the nip portion of the upstream roller pair to the nip portion of the downstream roller pair, and in a case where the conveyance path is curved, the measurement should be taken along an inner guide of the curve (upper guide 301a, lower guide 302b).

### Variant Example 1

In the embodiment described above, the angle θ1 is larger than the angle θ2. It is not limited to this, and, for example, it is acceptable to apply this technique to a configuration in which the angle θ1 is smaller than the angle θ2. In this variant example, the bending angle (θ2) of the conveyance path between the first and second registration roller pairs 243 and 244 is larger than the bending angle (θ1) of the upper conveyance path α on the upstream side. In this case, for the sheet S, such as the thin paper, whose stiffness is low, the skew correction may be performed in the first registration roller pair 243 so as to form the loop in the upper conveyance path α. In addition, for the sheet S, such as the thick paper, whose stiffness is high, the skew correction may be performed in the second registration roller pair 244 so as to form the loop in the conveyance path between the first and second registration roller pairs 243 and 244.

That is, in the thick paper mode (first mode) of this variant example, the sheet S is passed through the first registration roller pair 243 (second roller pair) without abutting the leading edge of the sheet S against the first registration roller pair 243 (second roller pair), which is in the stopped state. Thereafter, the skew correction of the sheet is performed by abutting the leading edge of the sheet against the second registration roller pair 244 (third roller pair), which is in the stopped state. In addition, in the thin paper mode (second mode) of this variant example, the skew correction of the sheet is performed by abutting the leading edge of the sheet against the first registration roller pair 243 (second roller pair), which is in the stopped state. Thereafter, the sheet S is passed through the second registration roller pair 244 (third roller pair) without abutting the leading edge of the sheet S against the second registration roller pair 244 (third roller pair), which is in the stopped state. The control unit 200 executes the thick paper mode (first mode) in a case where the grammage of the sheet is the first grammage, and executes the thin paper mode (second mode) in a case where the grammage of the sheet is the second grammage, which is less than the first grammage.

As a result, as with the embodiment described above, it is possible to provide the sheet conveyance apparatus and the image forming apparatus that can realize enhanced accuracy in the skew correction for a variety of sheets.

### Variant Example 2

In addition, while, in the embodiment described above, the thick paper mode and the thin paper mode are determined based on the grammage, it is acceptable to determine the thick paper mode and the thin paper mode based on parameters other than the grammage. For example, the thick paper mode may be applied to coated paper with a resin layer formed on its surface, regardless of its grammage. In addition, since recycled paper may exhibit lower stiffness compared to standard paper even at equivalent grammage, it may be appropriate to apply the thin paper mode for the recycled paper. In addition, by presetting the thick paper mode/thin paper mode based on combinations of information other than the grammage and grammage information, and storing the combinations in the memory 202 of the control unit 200 in a form of a table or the like, the thick paper mode/thin paper mode can be determined by referencing the table or the like when executing the print job.

Even in a case where the selection of the thick and thin paper modes is determined based on criteria different from those in the embodiment, the control unit 200 executes the thick paper mode (first mode) for a first sheet with high stiffness, and executes the thin paper mode (second mode) for a second sheet with low stiffness. As a result, regardless of differences in the grammage, it is possible to provide the sheet conveyance apparatus and the image forming apparatus that can realize enhanced accuracy in the skew correction for a variety of sheets.

### Other Variant Example

While, in the embodiment described above, either of the two modes (thick paper mode and thin paper mode) is applied, the control unit 200 may also be capable of executing an alternative mode (third mode) different from both the thick paper mode and the thin paper mode. The alternative mode described above may be, for example, a mode in which, after performing an initial skew correction by abutting the leading edge of the sheet against the first registration roller pair 243, which is in the stopped state, the control unit 200 performs a second skew correction by abutting the leading edge of the sheet against the second registration roller pair 244, which is in the stopped state. With this mode, by repeatedly performing the skew correction, accuracy in the skew correction can be further enhanced. In addition, the alternative mode described above may be, for example, a mode in which the skew correction is not performed in either of the first and second registration roller pairs 243 and 244, and, thereby, expedited sheet conveyance is prioritized.

According to this disclosure, it is possible to provide the sheet conveyance apparatus and the image forming apparatus that can realize enhanced accuracy in the skew correction for a variety of sheets.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-122481, filed Jul. 29, 2024, which is hereby incorporated by reference herein in its entirety.

What is claimed is:

1. A sheet conveyance apparatus comprising:
a first roller pair configured to convey a sheet;
a second roller pair arranged downstream of the first roller pair in a conveyance path of the sheet and configured to convey the sheet;
a third roller pair arranged downstream of the second roller pair in the conveyance path and configured to convey the sheet; and
a control unit,
wherein, in a case where a movement direction of the sheet at a nip portion of the first roller pair is referred to as a first direction, a movement direction of the sheet at a nip portion of the second roller pair is referred to as a second direction, and a movement direction of the sheet at a nip portion of the third roller pair is referred to as a third direction, an angle between the first direction and the second direction is larger than an angle between the second direction and the third direction,
wherein the control unit is configured to execute a first mode in a case of conveying the sheet having a first grammage and to execute a second mode in a case of conveying the sheet having a second grammage that is less than the first grammage,
wherein the first mode is a mode in which skew correction of the sheet is performed by abutting a leading edge of the sheet against the second roller pair in a stopped state, and then the sheet is passed through the third roller pair without abutting the leading edge of the sheet against the third roller pair in a stopped state, and
wherein the second mode is a mode in which the leading edge of the sheet is passed through the second roller pair without abutting against the second roller pair in the stopped state, and then skew correction of the sheet is performed by abutting the leading edge of the sheet against the third roller pair in the stopped state.

2. The sheet conveyance apparatus according to claim 1, further comprising:
a first guide; and
a second guide configured to form the conveyance path of the sheet with the first guide between the first roller pair and the second roller pair,
wherein the conveyance path of the sheet is curved such that the second guide is positioned on an outer side of a curve, and
wherein, when performing the skew correction of the sheet in the first mode, the first guide and the second guide are configured to allow the sheet to warp toward the outer side of the curve.

3. The sheet conveyance apparatus according to claim 2, further comprising:
a third guide; and
a fourth guide arranged on a lower side of the third guide and configured to form the conveyance path of the sheet with the third guide between the second roller pair and the third roller pair,
wherein the third guide is configured to form a space that allows the sheet to warp upward when performing the skew correction of the sheet in the second mode.

4. The sheet conveyance apparatus according to claim 2,
wherein the nip portion of the second roller pair is arranged at a position lower than the nip portion of the first roller pair,
wherein the first direction is a direction directed downward in a vertical direction, and is a direction closer to the vertical direction than to a horizontal, and
wherein the second direction is a direction closer to the horizontal than to the vertical direction.

5. The sheet conveyance apparatus according to claim 4,
wherein the control unit is configured to:
cause the sheet to warp downward between the first roller pair and the second roller pair by executing the first mode; and
cause the sheet to warp upward between the second roller pair and the third roller pair by executing the second mode.

6. The sheet conveyance apparatus according to claim 1, further comprising:
a third guide; and
a fourth guide arranged on a lower side of the third guide and configured to form the conveyance path of the sheet with the third guide between the second roller pair and the third roller pair,
wherein the third guide is configured to form a space that allows the sheet to warp upward when performing the skew correction of the sheet in the second mode.

7. The sheet conveyance apparatus according to claim 1,
wherein the conveyance path is a first conveyance path,
wherein the sheet conveyance apparatus further comprises a fourth roller pair arranged in a second conveyance path that merges with the first conveyance path, the fourth roller pair being configured to convey the sheet toward the second roller pair,
wherein, in a case where a movement direction of the sheet at a nip portion of the fourth roller pair is referred to as a fourth direction, an angle between the fourth direction and the second direction is larger than the angle between the second direction and the third direction, and
wherein the control unit is configured to execute the first mode in a case of conveying the sheet having the first grammage via the second conveyance path and to execute the second mode in a case of conveying the sheet having the second grammage via the second conveyance path.

8. The sheet conveyance apparatus according to claim 1, further comprising:
a position detection unit configured to detect an edge position of the sheet in a sheet width direction that is parallel to rotational axes of the third roller pair; and
a moving unit configured to move the third roller pair in the sheet width direction based on a detection result of the position detection unit.

9. A sheet conveyance apparatus comprising:
a first roller pair configured to convey a sheet;
a second roller pair arranged downstream of the first roller pair in a conveyance path of the sheet and configured to convey the sheet;
a third roller pair arranged downstream of the second roller pair in the conveyance path and configured to convey the sheet; and
a control unit,
wherein, in a case where a movement direction of the sheet at a nip portion of the first roller pair is referred to as a first direction, a movement direction of the sheet at a nip portion of the second roller pair is referred to as a second direction, and a movement direction of the sheet at a nip portion of the third roller pair is referred to as a third direction, an angle between the first direction and the second direction is smaller than an angle between the second direction and the third direction,
wherein the control unit is configured to execute a first mode in a case of conveying the sheet having a first grammage, and is configured to execute a second mode in a case of conveying the sheet having a second grammage that is less than the first grammage,
wherein the first mode is a mode in which a leading edge of the sheet is passed through the second roller pair without abutting against the second roller pair in a stopped state, and then skew correction of the sheet is performed by abutting the leading edge of the sheet against the third roller pair in a stopped state, and
wherein the second mode is a mode in which skew correction of the sheet is performed by abutting the leading edge of the sheet against the second roller pair in the stopped state, and then the sheet is passed through the third roller pair without abutting the leading edge of the sheet against the third roller pair in the stopped state.

10. A sheet conveyance apparatus comprising:
a first roller pair configured to convey a sheet;
a second roller pair arranged downstream of the first roller pair in a conveyance path of the sheet and configured to convey the sheet;
a third roller pair arranged downstream of the second roller pair in the conveyance path and configured to convey the sheet; and
a control unit,
wherein, in a case where a movement direction of the sheet at a nip portion of the first roller pair is referred to as a first direction, a movement direction of the sheet at a nip portion of the second roller pair is referred to as a second direction, and a movement direction of the sheet at a nip portion of the third roller pair is referred to as a third direction, an angle between the first direction and the second direction is larger than an angle between the second direction and the third direction,
wherein the control unit is configured to execute a first mode in a case of conveying a first sheet, and is configured to execute a second mode in a case of conveying a second sheet having a lower stiffness than the first sheet,
wherein the first mode is a mode in which skew correction of the sheet is performed by abutting a leading edge of the sheet against the second roller pair in a stopped state, and then the sheet is passed through the third roller pair without abutting the leading edge of the sheet against the third roller pair in a stopped state, and
wherein the second mode is a mode in which the leading edge of the sheet is passed through the second roller pair without abutting against the second roller pair in the stopped state, and then skew correction of the sheet is performed by abutting the leading edge of the sheet against the third roller pair in the stopped state.

11. An image forming apparatus comprising:
the sheet conveyance apparatus according to claim 1; and
an image forming unit configured to form an image on the sheet conveyed by the sheet conveyance apparatus.
